(19) United States
(12) Patent Application Publication
(10) Pub. No.: US 2026/0208771 A1
(43) Pub. Date: Jul. 23, 2026

(54) METHOD FOR MONITORING A CABLEWAY

(71) Applicant: Innova Patent GmbH, Wolfurt (AT)

(72) Inventor: Severin HEYNEN, Buochs (CH)

(73) Assignee: Innova Patent GmbH, Wolfurt (AT)

(21) Appl. No.: 19/454,928

(22) Filed: Jan. 21, 2026

(30) Foreign Application Priority Data
Jan. 22, 2025 (AT) A50032/2025

(51) Int. Cl. B61B 12/06; B61B 7/00; G01M 5/00

(52) U.S. Cl. CPC B61B 12/06; B61B 7/00; G01M 5/0025

(57) ABSTRACT

A method for improved monitoring of a cableway, in which a number of sensors on at least one cableway support simultaneously detect a longitudinal measurement value and a transverse measurement value at at least one point in time during operation or when the cableway is stationary. An evaluation unit of the cableway receives and processes the simultaneously detected longitudinal measurement value and transverse measurement value at the at least one point in time. A defined mathematical operation is established in the evaluation unit between the simultaneously detected longitudinal measurement value and the transverse measurement value simultaneously detected at the at least one point in time and a result is ascertained from the defined mathematical operation. If a specified condition is met by the ascertained result, a problem with the cableway is signaled to a control unit, which controls the cableway depending upon the problem signaled.

### CROSS-REFERENCE TO RELATED APPLICATION

This application claims priority under 35 U.S.C. § 119(a) to Austria Application No. A50032/2025 filed Jan. 22, 2025, the disclosure of which is expressly incorporated by reference herein in its entirety.

### BACKGROUND

### 1. Field of the Invention

Embodiments relate to a method for monitoring a cableway, wherein, during operation of the cableway, a number of cableway vehicles are moved on a hoisting cable in a conveying direction along a number of cableway supports. A number of sensors are provided on at least one of the cableway supports, and a movement of the cableway support along the conveying direction is detected by the number of sensors as a longitudinal measurement value, and at least one movement of the cableway support transverse to the conveying direction is detected as a transverse measurement value along a transverse measurement direction. Embodiments also relate to a cableway having the monitoring according to the invention.

### 2. Discussion Of Background Information

Cableways are known in a wide variety of designs, mostly for transporting people and/or goods—for example, as urban means of transport or for transporting people in ski areas. Here, cableway vehicles such as cars or chairs are carried by one or more (wire) cables without fixed guides, and moved while hanging in the air. In addition, cableways, so-called combined cableways, are also known which allow for mixed operation with gondola vehicles and chairlift vehicles as cableway vehicles. Cableways are usually used in rough terrain, mostly for mountain routes, e.g., in ski areas, to transport people and/or objects from the valley to a mountain, but also in urban areas for transporting people. As a rule, cableways have at least two cableway stations between which the cableway vehicles are moved.

A distinction must be made between circulating cableways and aerial cableways. In the case of aerial cableways, one or two cableway vehicles pulled by a traction cable travel back and forth on a hoisting cable between two cableway stations. Circulating cableways, on the other hand, have a continuous hoisting cable that is constantly circulating between the cableway stations and on which a plurality of cableway vehicles, such as cars or chairs, are suspended. The cableway vehicles are moved from one cableway station to the other on one side and back again on the opposite side. The movement of the cableway vehicles is therefore always essentially continuous in one direction, and analogous to that of a continuous conveyor.

In modern circulating cableways, the cableway vehicles are usually not permanently connected to the hoisting cable, but are releasably connected by openable cable clamps. As a result, the cableway vehicles can be decoupled from the hoisting cable in the cableway stations and moved through the cableway station at a speed that is lower than the speed of the hoisting cable. When exiting the cableway station, the cableway vehicles are then clamped to the hoisting cable again by means of the cable clamps. As a rule, the cableway vehicles are (releasably) attached to the hoisting cable at a defined distance from one another. In order to ensure, in particular, that the load on the hoisting cable is as even as possible, the distances between the cableway vehicles on a cableway are usually (approximately) the same.

In order to be able to bridge greater distances, a number of cableway supports for guiding the (carrying/traction) cable(s) are usually arranged between the two cableway stations. Cableway supports can be designed as a steel framework construction, but also as a steel tube or sheet metal box construction. A plurality of cable rollers, e.g., in the form of a so-called roller set, are usually arranged on a cableway support in order to carry and guide the cable. As a rule, the distances between the cableway vehicles mean that there is only one cableway vehicle on a cableway support (at least in one direction of travel) between an entry region into the roller set and an exit region from the roller set.

To increase the operational safety of the cableway and thus the safety of the passengers, EP 3 375 686 A1 or EP 3 620 340 B1 proposes that sensors be provided on the roller sets to monitor operation.

During operation of the cableway, it may occur under certain circumstances that, when the cableway vehicle passes through or over the cableway support, the cableway vehicle becomes jammed, in particular the cable clamp of the cableway vehicle in the roller set or a transport body of the cableway vehicle on the cableway support itself, so that the cableway vehicle is thus blocked. For safety reasons, the cable clamps are usually designed in such a way that, when there is a certain resistance between the cableway vehicle and the hoisting cable, they allow the hoisting cable to slip through (without loosening the clamp, of course). The scenario described could consequently lead to the cableway vehicle being blocked in the region of a roller set and the hoisting cable being moved through the cable clamp at a substantially unchanged speed relative to the cableway vehicle.

A blocked cableway vehicle cannot be easily detected by a cableway control unit. If the cableway support cannot be seen from a cableway station, a blocked cableway vehicle cannot be recognized by the operating staff.

### SUMMARY

Embodiments improve the monitoring of a cableway in order to increase the safety of the cableway, in particular during operation.

In embodiments, the number of sensors simultaneously detect longitudinal measurement value and transverse measurement value at at least one point in time during operation or when the cableway is stationary. An evaluation unit of the cableway receives and processes the longitudinal measurement value and transverse measurement value simultaneously detected at the at least one point in time by the number of sensors. In the evaluation unit, a defined mathematical operation is established between the longitudinal measurement value and the transverse measurement value simultaneously detected at the at least one point in time and a result is ascertained from the defined mathematical operation. If a specified condition is met by the ascertained result, the evaluation unit signals a problem with the cableway to a control unit of the cableway for monitoring, and the control unit controls the cableway depending upon the problem signaled by the evaluation unit.

During operation of the cableway, but also when the cableway is stationary, problematic events can occur that trigger a characteristic movement pattern of the cableway support, e.g., a twisting of the cableway support about a vertical axis and/or an inclination of the cableway support in the direction of a longitudinal or transverse axis. A problematic event could, for example, be a cableway vehicle becoming blocked while passing along a cableway support or a tree falling onto the hoisting cable near the cableway support. According to embodiments, simultaneous detection of longitudinal and transverse measurement values by the number of sensors on the cableway support and subsequent evaluation is proposed. This makes it possible to identify, as a problem with the cableway, such events at or in the vicinity of the cableway support(s) that previously remained undetected by the cableway control unit or by the operating personnel, based upon the substantially simultaneous occurrence of the (increased) longitudinal and transverse measurement values. The method can also be easily and flexibly retrofitted to existing cableways.

Preferably, the number of sensors detect a plurality of transverse measurement values, preferably two transverse measurement values, wherein at least two of the plurality of transverse measurement values are detected in different transverse measurement directions. By evaluating the longitudinal measurement value and the plurality of transverse measurement values, the accuracy in detecting problematic events at or in the vicinity of the cableway support(s) is increased.

Preferably, during operation of the cableway, the number of sensors on the at least one cableway support simultaneously detect a longitudinal measurement value and a transverse measurement value at at least one point in time during passage of one of the cableway vehicles along the cableway support, wherein the evaluation unit, if the specified condition is met by the ascertained result, signals a problem in the passage of the cableway vehicle past the cableway support to the control unit of the cableway for passage monitoring, and the control unit controls the cableway depending upon the problem signaled by the evaluation unit. In particular when cableway vehicles pass along the individual cableway supports, problematic events can occur if, for example, a cable clamp of the cableway vehicle gets caught in a roller set of the cableway support or a transport body of the cableway vehicle gets caught on the cableway support itself. These problematic events trigger characteristic movement patterns of the cableway support, which can be easily detected using the method according to the invention in order to control the cableway accordingly.

Preferably, the number of sensors detect an acceleration in each case as the longitudinal measurement value and the transverse measurement value. In the case of problematic events, such as a cableway vehicle becoming blocked or a tree falling onto the hoisting cable, this is apparent in particular in an abrupt and increased acceleration of the cableway support in the measurement directions of the number of sensors, making the detection of the accelerations particularly advantageous.

Preferably, the number of sensors simultaneously detect the longitudinal measurement value and the transverse measurement value at a plurality of points in time during operation of the cableway, particularly preferably during the passage of one of the cableway vehicles along the cableway support, or when the cableway is stationary. This makes it possible to ensure that problematic events are reliably detected. Furthermore, the points in time or time intervals between the points in time can be defined depending upon the operation and/or the embodiment of the cableway, making the method flexible and individually adaptable to the specific cableway.

The mathematical operation is preferably defined as addition, multiplication, or correlation. Various mathematical operations can be used for the method according to the invention, which further increases the flexibility of the method.

Preferably, exceedance of a defined maximum value by the ascertained result of the mathematical operation is specified as the condition. In this case, the maximum value is preferably defined depending upon the operation of the cableway, preferably upon a conveying speed of the cableway vehicles on the hoisting cable, and/or upon the embodiment of the cableway. This makes it possible to determine a suitable maximum value very individually, depending upon the specific cableway (e.g., number and type of supports, operating mode, etc.). For example, the specified condition, in particular the maximum value, is determined in advance through calibration.

The evaluation unit preferably additionally processes the longitudinal measurement value and transverse measurement value, detected simultaneously at at least one point in time, by determining an absolute value of the longitudinal measurement value and an absolute value of the transverse measurement value in order to establish the defined mathematical operation and to ascertain the result from the defined mathematical operation. With this preprocessing, the evaluation according to the invention can be performed in a simple manner, regardless of the orientation of the measurement direction of the number of sensors, i.e., regardless of the sign of the measurement value, depending upon the movement of the cableway support.

Embodiments are also directed to a cableway, in which the number of sensors are configured to simultaneously detect a longitudinal measurement value and a transverse measurement value at at least one point in time during operation or when the cableway is stationary. The cableway includes an evaluation unit that is configured to receive and process the longitudinal measurement value and the transverse measurement value, detected simultaneously at the at least one point in time, from the number of sensors. The evaluation unit is further configured to establish a defined mathematical operation between the longitudinal measurement value and transverse measurement value detected simultaneously at the at least one point in time and to ascertain a result from the defined mathematical operation. The cableway can include a control unit, and the evaluation unit is configured, if a specified condition stored in the evaluation unit is met by the ascertained result, to signal a problem with the cableway to the control unit for monitoring the cableway. The control unit is configured to control the cableway depending upon the problem signaled by the evaluation unit. This makes it possible to identify, as a problem with the cableway, problematic events at or in the vicinity of the cableway support(s) that previously remained undetected by the cableway control unit or by the operating personnel, based upon the substantially simultaneous occurrence of the (increased) longitudinal and transverse measurement values.

In a preferred embodiment, one sensor is provided as the number of sensors, which is configured to detect the longitudinal measurement value and the transverse measurement value, preferably two transverse measurement values in different transverse measurement directions. Using a sensor reduces complexity. Furthermore, more complex movements of the cableway support can be reliably detected using the two detected transverse measurement values.

Preferably, the number of sensors are provided on more than one of the cableway supports, particularly preferably on each cableway support. As a result, essentially the entire cableway between the cableway stations can be monitored, and problematic events are reliably detected, thereby increasing the safety of the cableway.

Advantageously, an accelerometer is provided as the respective sensor for the number of sensors. In the case of problematic events, such as a cableway vehicle becoming blocked, this is apparent in particular in an abrupt and increased acceleration of the cableway support, making the detection of accelerations advantageous.

Other exemplary embodiments and advantages of the present invention may be ascertained by reviewing the present disclosure and the accompanying drawing.

### BRIEF DESCRIPTION OF THE DRAWINGS

The present invention is described in greater detail below with reference to FIGS. 1 to 5b, which show, by way of example, advantageous embodiments of the invention in a schematic and non-limiting manner. In the figures:

FIG. 1 shows a cableway with two cableway supports and two cableway stations;

FIG. 2 is a side view of a passage of a cableway vehicle along one of the cableway supports of the cableway;

FIG. 3 is a plan view of the cableway support with the cable clamp of the cableway vehicle blocked;

FIG. 4A is a frontal view of a transverse inclination of a carrying support tower relative to the conveying direction;

FIG. 4B is a side view of an inclination of the carrying support tower in the conveying direction;

FIG. 5A is a frontal view of a transverse inclination of a hold-down support tower relative to the conveying direction; and

FIG. 5B is a side view of an inclination of the hold-down support tower in the conveying direction.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

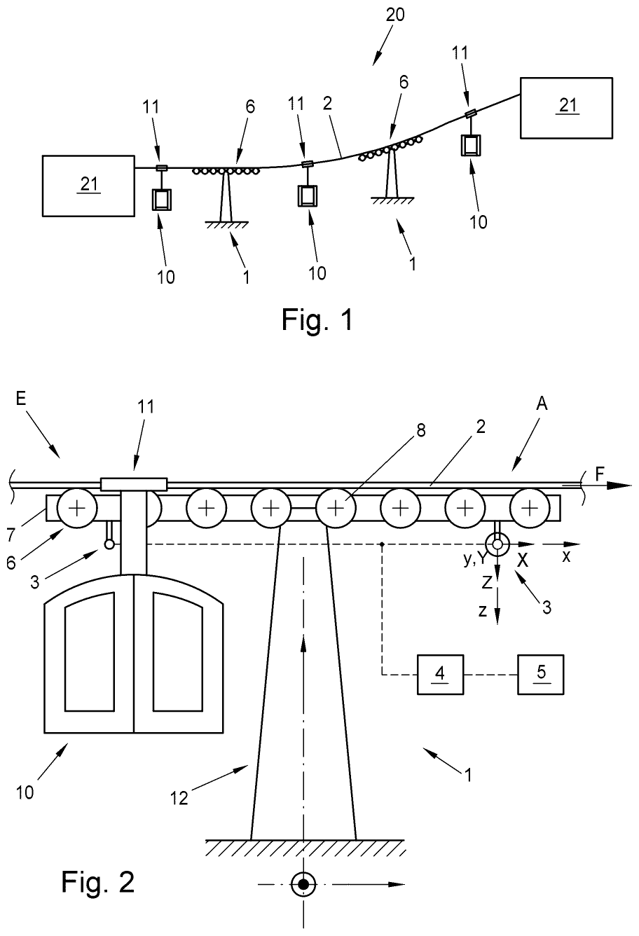

FIG. 1 shows a schematic and exemplary cableway 20. The cableway 20 comprises two cableway stations 21, e.g., a valley station and a mountain station designed as end stations. Between the two cableway stations 21, a number of cableway vehicles 10 are moved by a hoisting cable 2. FIG. 1 shows three cableway vehicles 10 by way of example, wherein, typically, significantly more cableway vehicles 10 are moved on the hoisting cable 2. The cableway vehicles 10 are typically fastened in a suspended manner to the hoisting cable 2 at a certain predetermined distance from one another, wherein the fastening preferably takes place by cable clamps 11 (releasable or fixedly clamped). In some embodiments of the cableway 20, a plurality of parallel hoisting cables 2 and, if applicable, a traction cable that circulates or runs back and forth can also be provided. The invention is explained in the following example without limitation of generality, with reference to only one circulating hoisting cable 2. Of course, the invention is also applicable to known cableways 20 having a plurality of hoisting cables 2 and/or traction cables or support cables.

Facilities of the cableway stations 21 provided for operation of the cableway 20, such as cable pulleys, a cableway drive, a station conveyor for transporting cableway vehicles 10 unclamped from the hoisting cable 2, etc., are sufficiently well known, which is why they are not shown or described in detail or described only to the extent necessary for understanding the invention.

In the exemplary embodiment shown in FIG. 1, the cableway 20 is designed as a circulating cableway, in particular as a gondola cableway, wherein the cableway vehicles 10 are designed as gondolas. Of course, other known embodiments of the cableway 20 would also be conceivable, such as, for example, a chairlift with cableway vehicles 10 designed as chairs, or drag lifts with tow bars. Mixed operation with a gondola alternating with a chair as cableway vehicles 10 would also be possible.

The cableway 20 comprises, for example, two cableway supports 1, which are arranged between the cableway stations 21. Naturally, the number of cableway supports 1 depends upon the embodiment of the cableway 20 and is typically significantly greater than two. The number of cableway supports 1 depends, for example, upon the distance between the cableway stations 21 of the cableway 20 and upon the expected load from the cableway vehicles 10, but also upon the topology of the terrain in which the cableway 20 is provided.

The cableway supports 1 are used to carry and guide the hoisting cable 2. For this purpose, at least one roller set 6 is arranged on the cableway support 1. FIG. 2 shows one of the cableway supports 1 of the cableway 20. The roller set 6 can have a longitudinal beam 7 on which a plurality of rollers 8 are arranged one behind the other. The rollers 8 are rotatably mounted on the roller set 6, e.g., on the longitudinal beam 7, and serve to carry the hoisting cable 2 and to guide it laterally. The roller set 6 thus supports the load of the hoisting cable 2 including the cableway vehicles 10 fastened thereto via the cableway support 1 on the ground. The roller set 6 is usually pivotably mounted on the cableway support 1—for example, via the longitudinal beam 7. Depending upon whether the hoisting cable 2 is guided so as to rest on the rollers 8 above the roller set 6 or whether the hoisting cable 2 is guided on the rollers 8 below the roller set 6, the cableway support 1 is referred to either as a carrying support tower or as a hold-down support tower. To overcome, for example, a steep slope, a hold-down support tower is typically provided at the beginning of the slope, and a carrying support tower is provided at the upper end of the slope.

The roller set 6 has an entry region E and an exit region A. During operation of the cableway 20, a cableway vehicle 10 moves in the conveying direction F through the entry region E along the roller set 6 provided on the cableway support 1 (as shown in FIG. 2) and exits the roller set 6 or the cableway support 1 through the exit region A.

In this connection, “operation of the cableway” means conveying the cableway vehicles 10 by moving the hoisting cable 2 in the conveying direction F, whereas in the “standstill of the cableway,” conveying the cableway vehicles 10 is interrupted, and the hoisting cable 2 is not moved further in the conveying direction F (e.g., the cableway drive of the cableway 20 is deactivated).

During operation of the cableway 20, the cableway vehicles 10 are moved on the hoisting cable 2 in the conveying direction F along the cableway supports 1. The conveying direction F is substantially defined by the longitudinal axis of the hoisting cable 2, wherein the conveying direction F, in a curved portion of the hoisting cable 2, is the tangent to the cable line of the hoisting cable 2.

According to the invention, a number of sensors 3 are provided on at least one of the cableway supports 1 of the cableway 20. The number of sensors 3 are configured to detect a movement of the cableway support 1 along the conveying direction F as a longitudinal measurement value X and to detect at least a movement transverse to the conveying direction F (hereafter also referred to as the transverse direction) as a transverse measurement value Y, Z. The transverse direction is a direction normal to the conveying direction F, wherein any normal to the conveying direction F is conceivable in principle. The number of sensors 3 have a plurality of different measurement directions. The number of sensors 3 are designed, along a first measurement direction x (hereafter referred to as longitudinal measurement direction), to detect the longitudinal measurement value X and, along at least one further measurement direction y, z (hereafter referred to as the transverse measurement direction), to detect the transverse measurement value Y, Z.

Preferably, the number of sensors 3 detect a plurality of transverse measurement values Y, Z, wherein at least two of the plurality of transverse measurement values Y, Z are detected in different transverse measurement directions y, z. Particularly preferably, the number of sensors 3 have a longitudinal measurement direction x and two different transverse measurement directions y, z (as shown in FIG. 2), wherein a first transverse measurement value Y is detected along one of the two transverse measurement directions y, and a second transverse measurement value Z is detected along the other transverse measurement direction z. For example, the first transverse measurement direction y is oriented horizontally, along which the first transverse measurement value Y (as a horizontal measurement value) is detected, and the second transverse measurement direction z is oriented vertically, along which the second transverse measurement value Z (as a vertical measurement value) is detected, as indicated in FIG. 2. Of course, the different transverse measurement directions y, z can also be oriented differently relative to one another.

Preferably, one sensor on the at least one cableway support 1 is configured as the number of sensors 3, i.e., the one sensor is configured to detect longitudinal measurement value X and transverse measurement value Y, preferably two transverse measurement values Y, Z in the different transverse measurement directions y, z. This results in the simplest possible embodiment of the monitoring of the cableway 20 according to the invention. Alternatively, more than one sensor can be provided on at least one cableway support 1 as the number of sensors 3. Accordingly, one or more sensors are arranged so that a longitudinal measurement value X and at least one transverse measurement value Y, Z are detected by the at least one sensor 3. The specific embodiment of the number of sensors 3 is of secondary importance to the invention. For example, one sensor 3 is a multi-axis (e.g., two-or three-axis) sensor, preferably a multi-axis accelerometer. Alternatively, or additionally, a number of single-axis sensors 3 can also be provided. For example, one of the sensors 3 detects the longitudinal measurement value X, and the other sensor(s) 3 each detect a transverse measurement value Y, Z. Thus, for example, a multi-axis sensor (e.g., a multi-axis accelerometer) can be substituted by at least two single-axis sensors (e.g., two single-axis accelerometers). However, hybrid forms of single-axis and multi-axis sensors are also conceivable as the number of sensors 3.

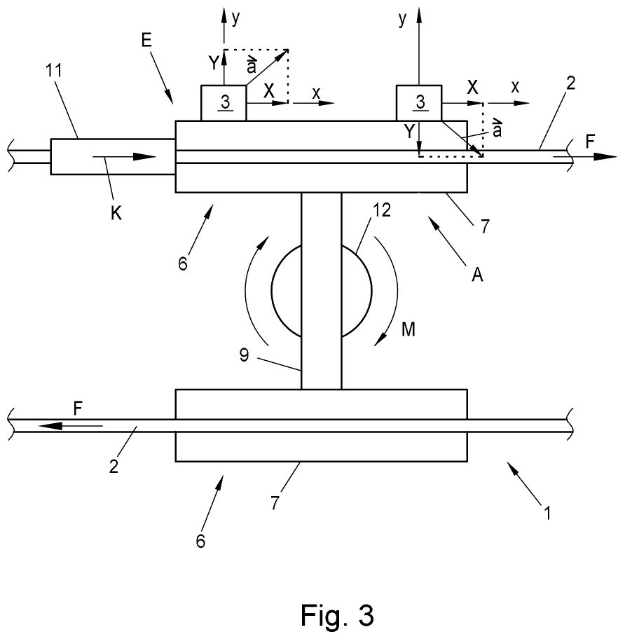

Furthermore, it is also conceivable that, in the case of a plurality of sensors 3 on the at least one cableway support 1, the individual sensors 3 each detect longitudinal measurement value X and transverse measurement value Y, Z in the same measurement directions x, y, z. Merely by way of example, two two-axis sensors are provided as the number of sensors 3 in FIG. 3, both of which detect the longitudinal measurement value X and the transverse measurement value Y in the same measurement directions x, y. For the evaluation according to the invention, the longitudinal measurement value X and the transverse measurement value Y are used by at least one of the two sensors 3, or, alternatively, by both sensors 3. As already mentioned, it is essential for the invention that a longitudinal measurement value X and at least one transverse measurement value Y, Z are detected by the number of sensors 3. As described in more detail below, the exemplary embodiment of the number of sensors 3 in FIG. 3 is intended to illustrate how the movement of the cableway support 1 affects the signs of the detected longitudinal and transverse measurement values.

The number of sensors 3 can, in principle, be arranged at any point on the cableway support 1. As shown by way of example in FIG. 3, a multi-axis sensor 3 is preferably arranged on the cableway support 1 in the entry region E and in the exit region A of the roller set 6 on the longitudinal beam 7. The sensor(s) 3 can also be arranged at another location on the cableway support 1, e.g., on the support 12 of the cableway support 1 itself or on a cross member 9 of the cableway support 1. It is important for the location of the sensor(s) 3 on the cableway support 1 that the measurement values according to the invention can be detected, as described below.

In FIGS. 2 and 3, the number of sensors 3 are shown only on one cableway support 1 of the cableway 20, although of course a number of sensors 3 can also be provided on a plurality of cableway supports 1 of the cableway 20. Preferably, a number of sensors 3 are provided on each cableway support 1 of the cableway 20. Preferably, the number of sensors 3 on each cableway support 1 are identical (e.g., same number and/or type of sensors 3).

The arrangement of the number of sensors 3 on the cableway support 1 influences the orientation of the measurement directions of the number of sensors 3 with respect to the conveying direction F and the transverse direction.

Depending upon the arrangement of the number of sensors 3 on the cableway support 1 and the orientation of the measurement directions x, y, z, it may be that the longitudinal measurement direction x does not exactly coincide with the conveying direction F and that at least one transverse measurement direction (e.g., the first transverse measurement direction y and/or, if present, the second transverse measurement direction z) does not exactly coincide with the transverse direction, which is the more likely case in practice. In this connection, detecting the longitudinal measurement value X “along the conveying direction F” means that the longitudinal measurement direction x of the number of sensors 3 is oriented relative to the conveying direction F such that detected the longitudinal measurement value X, in the longitudinal measurement direction x of the number of sensors 3, has at least a longitudinal component in the conveying direction F. In this connection, detecting the transverse measurement value Y, Z “transverse to the conveying direction F” means that the transverse measurement direction y, z of the number of sensors 3 is oriented relative to the transverse direction such that the detected transverse measurement value Y, Z, in the transverse direction y, z of the number of sensors 3, has at least a transverse component in the transverse direction.

Of course, depending upon the arrangement of the number of sensors 3 on the cableway support 1 and the orientation of the measurement directions x, y, z, the longitudinal measurement value X can also have a transverse component in the transverse direction, and the transverse measurement value(s) Y, Z can also have a longitudinal component in the conveying direction F.

A movement of the cableway support 1 can, for example, be a twist and/or an inclination of the cableway support 1, as will be described in more detail below. The magnitude of the longitudinal measurement value X detected along the longitudinal measurement direction x and the magnitude of the transverse measurement value Y, Z detected along a transverse measurement direction y, z depend, in addition to the arrangement of the number of sensors 3 on the cableway support 1 and the orientation of the measurement directions x, y, z of the number of sensors 3, in particular upon the movements of the cableway support 1 that occur during operation and/or when the cableway 20 is stationary. Depending upon how far and in which direction (along and/or transversely to the conveying direction F) the cableway support 1 moves, the magnitude of the particular detected measurement value X, Y, Z, and consequently also the magnitudes of the longitudinal and transverse components, change. The movements of the cableway support 1 that occur depend in particular upon the operation of the cableway 20, e.g., upon the conveying speed of the cableway vehicles 10, whether a problematic event occurs, etc., and/or upon the embodiment of the cableway 20.

What is essential for the invention is that the number of sensors 3 are arranged on the cableway support 1 and the measurement directions x, y, z are oriented in such a way that, under the movements of the cableway support 1 that are expected to occur during operation and/or when the cableway 20 is stationary, the longitudinal measurement value X and the transverse measurement values Y, Z are still sufficiently detected to be evaluated for the method according to the invention. The lower limit of the detected longitudinal measurement value X and of the particular detected transverse measurement value Y, Z is defined by the measuring range and the measuring accuracy of the number of sensors 3.

Preferably, the longitudinal measurement direction x of the number of sensors 3 is oriented such that the longitudinal component of the longitudinal measurement value X is greater than the transverse component of the longitudinal measurement value X, and/or that the particular transverse measurement direction y, z of the number of sensors 3 is oriented such that the longitudinal component of the transverse measurement value Y, Z is less than the transverse component of the transverse measurement value Y, Z. Particularly preferably, the measurement directions x, y, z of the number of sensors 3 are oriented such that the longitudinal measurement direction x substantially coincides with the conveying direction F, and the particular transverse measurement direction y, z is normal to the conveying direction F. In this case, the longitudinal measurement value X has only the longitudinal component, and the transverse measurement value Y, Z has only the transverse component. Particularly preferably, the number of sensors 3 are designed such that the measurement directions x, y, z are normal to one another, as indicated by way of example in FIG. 2.

With regard to the longitudinal measurement value X and the transverse measurement value(s) Y, Z, the influence of the sign must be taken into account. Depending upon the movement of the cableway support 1 that occurs, the sign of the detected measurement value X, Y, Z can change along the particular measurement direction x, y, z. Preferably, an absolute value of the longitudinal measurement value X and an absolute value of the particular transverse measurement value Y are determined, as described in more detail below.

Depending upon the type of sensors 3 and measurement principle used, the measurement value X, Y, Z can, for example, be a deflection, a speed, or an acceleration in the measurement directions x, y, z of the number of sensors 3. Alternatively, as the longitudinal measurement value X or as the transverse measurement values Y, Z, an angle, an angular velocity, or an angular acceleration around the measurement directions x, y, z of the number of sensors 3 can also be detected. In the case where, for example, an angular acceleration is measured, this can additionally be converted in a known manner into a linear acceleration (e.g., as a tangential acceleration) in the particular measurement direction x, y, z of the number of sensors 3 in order to determine the longitudinal measurement value X and the transverse measurement value(s) Y, Z. The same applies, of course, to the angle and the angular velocity.

A multi-axis sensor, in particular a multi-axis accelerometer, is preferably used as the number of sensors 3. For example, a capacitive or piezoelectric accelerometer can be used. The multi-axis accelerometer measures an acceleration along the conveying direction F as a longitudinal measurement value X and an acceleration transverse to the conveying direction F as at least one transverse measurement value Y, Z. As already mentioned, the multi-axis accelerometer can also detect two transverse measurement values Y, Z. Alternatively, at least two sensors can be provided as the number of sensors 3, wherein one of the sensors, for example, detects the longitudinal measurement value X and another of the sensors detects the transverse measurement value(s) Y, Z. Thus, for example, a multi-axis accelerometer can be replaced by at least two separate, single-axis accelerometers. A gyroscope can also be provided that detects a rotational movement of the cableway support 1 (e.g., angular velocity) in order to determine the longitudinal measurement value X and the transverse measurement value(s) Y, Z.

FIG. 3 is a plan view of the cableway support 1. The cableway support 1 has two roller sets 6, wherein the hoisting cable 2 is moved on the particular roller set 6 in the opposite conveying direction F (in the case of the circulating cableway). Furthermore, a problematic event is depicted, wherein the cable clamp 11 of the cableway vehicle 10 becomes entangled in the entry region E of one of the two roller sets 6 of the cableway support 1 and thereby blocks the cableway vehicle 10. The blocked cableway 10 exerts a force K on the roller set 6 via the cable clamp 11, substantially in the conveying direction F. As a result of the force K, a reaction force is produced at the cableway support 1, causing the cableway support 1, in particular the upper part of the cableway support 1 comprising the roller sets 6 and the cross member 9, to move or twist (a moment M is produced). The twisting causes torsion of the cableway support 1. The twisting of the cableway support 1 is indicated by arrows in FIG. 3 as a horizontal twisting. In practice, the twisting of the cableway support 1, as a movement of the cableway support 1, can additionally be superimposed with an inclination of the cableway support 1 around at least one further axis of the cableway support 1.

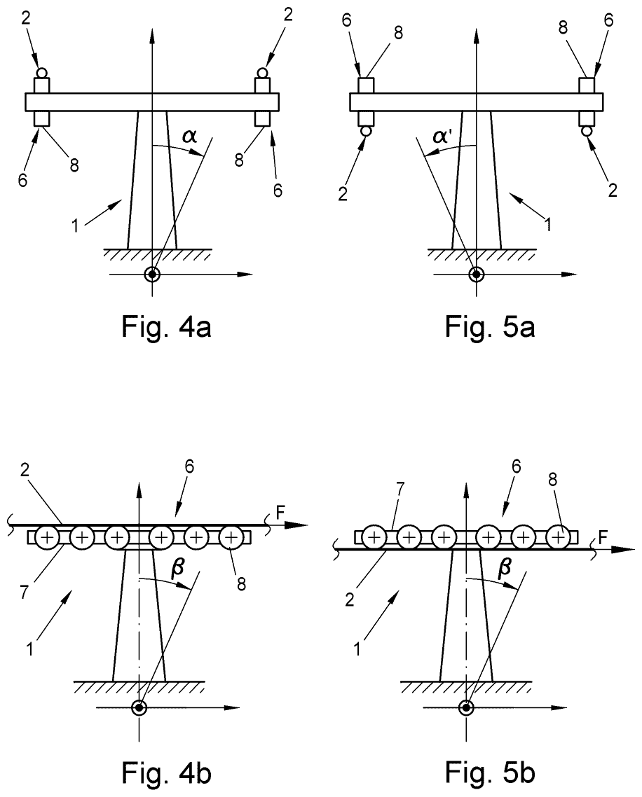

FIGS. 4A and 5A each schematically show an inclination of the cableway support 1 transverse to the conveying direction F. The direction of the inclination depends in particular upon the direction of the applied force K (e.g., from the cable clamp 11) and the type of cableway support 1. With the force K acting in the conveying direction F in the same direction, as shown in FIG. 3, the cableway support 1, as a carrying support tower (FIG. 4A), is inclined by an angle α. With the same force direction in the conveying direction F, the cableway support 1, as the hold-down support tower, is inclined by an angle α′ in the opposite direction (FIG. 5A). This different inclination direction has a particular influence on the sign of the detected measurement value X, Y, Z along the particular measurement direction x, y, z of the number of sensors 3 and can be taken into account accordingly in the evaluation.

Furthermore, the cableway support 1 can incline further along the conveying direction F, which is indicated merely by way of example in FIG. 4B (carrying support tower) and 5B (hold-down support tower) with an angle β. In this case, the inclination direction depends upon the force direction of force K (in the conveying direction F) from the blocked cable clamp 11 and is independent of the type of cableway support 1.

The blocking of the cableway vehicle 10 at the cableway support 1 typically occurs suddenly, wherein the cableway support 1 moves and accelerates as described, wherein the number of sensors 3 measure increased measurement values in at least two measurement directions. In the case of the multi-axis accelerometer as the number of sensors 3, accelerations are detected, as indicated in FIG. 3, along the longitudinal measurement direction x as the longitudinal measurement value X and along the transverse measurement direction y as the transverse measurement value Y. For the sake of clarity, FIG. 3 shows the sensors 3 schematically on only one of the two roller sets 6. The previously described preferred orientation of the two measurement directions x, y of the number of sensors 3 is shown, wherein the longitudinal measurement direction x, along which the longitudinal measurement value X is detected, coincides with the conveying direction F, and the transverse measurement direction y, along which the transverse measurement value Y is detected, is normal to the conveying direction F, i.e., coincides with the transverse direction.

The acceleration of the sensors 3 on the cableway support 1 is shown merely schematically in FIG. 3 with the vectors a. Depending upon how the cableway support 1 moves, the orientation of the particular vector a with respect to the two measurement directions x, y of the particular sensor 3 can change, which, as already described, can change the sign of the longitudinal measurement value X and the transverse measurement value Y accordingly. In FIG. 3, the horizontal twisting of the cableway support 1 causes the two vectors a to be oriented differently, whereby the transverse measurement value Y is detected with a positive sign at the sensor 3 in the entry region E and the transverse measurement value Y is detected with a negative sign at the sensor 3 in the exit region A.

During normal operation of the cableway 20, i.e., when no problematic event as described occurs, operation can cause movement of the cableway support 1—for example, dynamic accelerations of the cableway support 1, e.g., when one of the cableway vehicles 10 is guided along the roller set 6 of the cableway support 1. Experiments have shown that the cableway support 1 substantially moves only in one measurement direction of the number of sensors 3, and therefore a significant measurement value is detected only in one measurement direction (e.g., increased acceleration as the longitudinal measurement value X along the longitudinal measurement direction x). However, as already mentioned, it was recognized that in problematic events, such as when the cableway vehicle 10 becomes blocked at the cableway support 1, increased measurement values occur in more than one measurement direction compared to normal operation; for example, an increased acceleration is detected as the longitudinal measurement value X along the longitudinal measurement direction x of the number of sensors 3 and as the transverse measurement value Y, Z along at least one transverse measurement direction y, z of the number of sensors 3.

However, problematic events independent of the cableway vehicles 10 or the cableway 20 (external events) can also trigger a movement of the cableway support 1, e.g., a branch or a tree falling onto the hoisting cable 2 in the region of one of the cableway supports 1, between two cableway supports 1 or between a cableway support 1 and a cableway station 21. In this case, the number of sensors 3 on one of the cableway supports 1 located near the event likewise detect increased measurement values along more than one measurement direction x, y, z. For example, compared to normal operation or a standstill of the cableway 20, the number of sensors 3 detect an increased acceleration as the longitudinal measurement value X along the longitudinal measurement direction x and as the transverse measurement value Y, Z along at least one transverse measurement direction y, z.

The occurrence of an increased measurement value, in particular a sudden acceleration, in more than one measurement direction of the number of sensors 3 is an indication that there has been a problem with the cableway 20. It should be noted that different accelerations occur at the cableway support 1 when the cableway 20 is in operation and when it is stationary. Typically, when stationary, essentially only accelerations induced at the cableway support 1 by cable oscillations of the hoisting cable 2 and/or by wind occur.

According to the invention, during operation or when the cableway 20 is stationary, the number of sensors 3 simultaneously detect the longitudinal measurement value X and the transverse measurement values Y, Z at at least one point in time t. Preferably, the number of sensors 3 detect a plurality of transverse measurement values Y, Z, wherein at least two of the plurality of transverse measurement values Y, Z are detected in different transverse measurement directions y, z. Particularly preferably, the number of sensors 3 simultaneously detect the longitudinal measurement value X and the transverse measurement values Y, Z at a plurality of points in time t during operation of the cableway 20, in particular during the passage of the cableway vehicle 10 along the cableway support 1, or when the cableway 20 is stationary. The points in time t can be temporally separated from one another by a specified time interval. The length of the specified time interval can, for example, be chosen depending upon the conveying speed of the cableway vehicles 10. The higher the conveying speed, the shorter the time intervals can be selected to be in order to reliably detect problematic events. For example, the length of the specified time interval is in the range between 10 ms and 500 ms.

In this connection, “simultaneously at at least one point in time” means that, at least at the same point in time t during operation or standstill of the cableway 20, the number of sensors 3 detect the longitudinal measurement value X and the transverse measurement value(s) Y, Z. Preferably, the number of sensors 3 continuously detect the longitudinal measurement value X and the transverse measurement values Y, Z during operation and when the cableway 20 is stationary. Since, in particular when using more than one sensor 3, transit times can influence the measurement, and, in practice, measurements cannot be carried out exactly simultaneously, the term “same point in time t” is essentially understood as a time period of a few microseconds to milliseconds within which the measurement values are detected (simultaneously).

An evaluation unit 4 (see FIG. 2) of the cableway 20 is provided, which is configured to receive the longitudinal measurement value X and transverse measurement value Y, Z, detected simultaneously at at least one point in time t, from the number of sensors 3. For this purpose, the evaluation unit 4 is connected, e.g., via a suitable wired or wireless connection, to the number of sensors 3. The evaluation unit 4 can be part of a control unit 5 of the cableway 20 or designed as a separate unit. The evaluation unit 4 and/or the control unit 5 is preferably microprocessor-based hardware-for example, a microcontroller or computer.

The evaluation unit 4 is further configured to process the detected and received longitudinal measurement value X and transverse measurement value Y, Z, wherein a defined mathematical operation is established between the longitudinal measurement value X and transverse measurement value Y, Z detected simultaneously at at least one point in time t, and a result is ascertained from the defined mathematical operation. In the event that the number of sensors 3 simultaneously detect the longitudinal measurement value X and a plurality of transverse measurement values Y, Z at at least one point in time t, the evaluation unit 4 is configured to receive these and to establish the defined mathematical operation between the longitudinal measurement value X and the plurality of transverse measurement values Y, Z detected simultaneously at at least one point in time t and to ascertain a result from the defined mathematical operation. A mathematical operation is preferably defined as addition, multiplication, or correlation. In the evaluation unit 4, a suitable algorithm can be stored that is designed to establish the defined mathematical operation between the longitudinal measurement value X and the transverse measurement value(s) Y, Z.

The evaluation unit 4 can also perform certain preprocessing operations on the detected measurement values X, Y, Z—for example, filtering, amplifying, or otherwise manipulating the measurement values X, Y, Z in another known way. The evaluation unit 4 can additionally process the longitudinal measurement value X and transverse measurement value Y, Z, detected simultaneously at at least one point in time t, by, for example, determining an absolute value of the longitudinal measurement value X and an absolute value of the transverse measurement value Y, Z, in order to establish the defined mathematical operation and to ascertain the result from the defined mathematical operation. The same also applies in the case of a plurality of transverse measurement values Y, Z. As a result, an influence of the sign of the detected measurement value X, Y, Z along the respective measurement direction x, y, z of the number of sensors 3 can be avoided.

The ascertained result is then compared with a specified condition, and it is checked whether the ascertained result fulfills the specified condition. This can comprise checking whether a specified limit value is exceeded or not met as a specified condition. The algorithm stored in evaluation unit 4 can also be configured to perform this comparison. The specified condition is stored in evaluation unit 4. The processing and evaluation of the measurement values X, Y, Z from the evaluation unit 4 preferably take place in real time.

Preferably, an exceedance of a defined maximum value by the ascertained result of the mathematical operation is specified as the condition. The specified condition, in particular the maximum value, can be defined depending upon the operation of the cableway 20, e.g., upon the conveying speed of the cableway vehicles 10 on the hoisting cable 2 in the conveying direction F. This means that, for example, the maximum value can be fixed as a specified condition or dynamically adapted to the conveying speed. Additionally or alternatively, the specified condition can also be defined depending upon the embodiment of the cableway 20. In this case, features of the embodiment of the cableway 20 that may have an influence on the specified condition are taken into account, e.g., the type and number of cableway supports 1, the type and number of cableway vehicles 10, the topology of the terrain on which the cableway 20 is operated, etc. The specified condition can be defined, for example, from empirical values and/or determined by means of calibration, as described in more detail below.

If the ascertained result meets the specified condition, the evaluation unit 4 signals a problem with the cableway 20 to the control unit 5 of the cableway 20. The evaluation unit 4 is connected, for example, via a suitable wired or wireless connection to the control unit 5. For example, the evaluation unit 4 sends a predefined signal, preferably an electrical or electromagnetic signal, to the control unit 5 to signal the problem with the cableway 20. The specific implementation of the predefined signal is within the skill of a person having ordinary skill in the art.

Depending upon the problem signaled by the evaluation unit 4, the control unit 5 then controls the cableway 20. The control unit 5 controls, for example, a cableway drive of the cableway 20 (not shown), which, for example, moves the hoisting cable 2, or another component of the cableway 20, which can be used to influence the operation of the cableway 20. For example, the cableway drive of cableway 20 is stopped, or the conveying speed of the cableway vehicles 10 is reduced by the cableway drive. Alternatively, or additionally, the control unit 5 can control the cableway 20 in that the control unit 5 controls a display unit (not shown). The display unit is designed to display the problem with cableway 20 to cableway personnel acoustically and/or visually. The display unit can, for example, be a screen having a loudspeaker in a control room of the cableway 20, e.g., in a cableway station 21. In the event that a problem with the cableway 20 is detected when the cableway 20 is stationary, the control unit 5 can control the cableway 20 by, for example, preventing the cableway 20 from being put into operation. Alternatively or additionally, the control unit 5 can, as also during operation of the cableway 20, inform the cableway personnel of the problem with the cableway 20 by means of the display unit.

Since a problem with the cableway 20 can occur in particular during the passage of the cableway vehicle 10 along the cableway support 1, the number of sensors 3 preferably simultaneously detect the longitudinal measurement value X and the transverse measurement value(s) Y, Z at at least one point in time t during this period. To determine when the cableway vehicle 10 passes along the cableway support 1, for example, further sensors (not shown), e.g., inductive sensors, can be provided on the cableway support 1, which are configured to detect the cableway vehicle 10, e.g., the cable clamp 11 of the cableway vehicle 10, during its passage. If the specified condition is met by the result ascertained therefrom, the evaluation unit 4 signals, for passage monitoring, a problem during passage of the cableway vehicle 10 past the cableway support 1 to the control unit 5 of the cableway 20, whereupon the control unit 5 controls the cableway 20 depending upon the problem signaled by the evaluation unit 4. For example, in this case, the cableway drive of cableway 20 can also be stopped, or the conveying speed of the cableway vehicles 10 can be reduced.

The specified conditions can be predefined for cableway 20. However, in order to define the predefined condition, a calibration of the monitoring of the cableway 20 according to the invention and of the number of sensors 3 can preferably also be carried out. In this case, the cableway 20 is operated, for example, at different conveying speeds of the cableway vehicles 10 on the hoisting cable 2, e.g., at a maximum conveying speed and at half of the maximum conveying speed and, if necessary, also at other conveying speeds. This allows the movements of the cableway support 1 that occur during normal operation (in the form of the longitudinal measurement value X and the transverse measurement value(s) Y, Z) to be detected by the number of sensors 3. A defined mathematical operation (also used during real operation) is established between the longitudinal measurement value X and the transverse measurement value(s) Y, Z detected simultaneously at at least one point in time t by the number of sensors 3 during calibration. The result ascertained from the defined mathematical operation then serves as a guideline value for defining the specified condition. For example, the limit or maximum value defined as the specified condition is selected as a multiple of the ascertained result. The underlying idea is that, in the event of a fault (occurrence of a problematic event), the longitudinal measurement value X and the transverse measurement value(s) Y, Z will deviate significantly from normal operation. Preferably, the defined maximum value is three to five times the guideline value. This is to ensure that, during normal operation of the cableway 20, i.e., without a problematic event, the defined maximum value is not exceeded by the result ascertained from longitudinal and transverse measurement value(s). However, even when the cableway 20 is stationary, comparable measurements can be carried out by the number of sensors 3 for calibration and to define the specified condition.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for monitoring a cableway during operation of the cableway, in which the cableway includes a number of cableway vehicles moved on a hoisting cable in a conveying direction along a number of cableway supports, and a number of sensors are provided on at least one of the cableway supports, the method comprising:
detecting, via the number of sensors, movement of the cableway support along the conveying direction as a longitudinal measurement value, and at least one movement of the cableway support transverse to the conveying direction as a transverse measurement value, the number of sensors simultaneously detecting the longitudinal measurement value and the transverse measurement value at at least one point in time during operation or when the cableway is stationary;
receiving and processing in an evaluation unit of the cableway the simultaneously detected longitudinal measurement value and transverse measurement value at the at least one point in time from the number of sensors,
wherein, in the evaluation unit, a defined mathematical operation is established between the simultaneously detected longitudinal measurement value and transverse measurement value at the at least one point in time, and ascertaining a result from the defined mathematical operation,
wherein, if a specified condition is met by the ascertained result, the evaluation unit signaling a problem with the cableway to a control unit that, depending upon the problem signaled by the evaluation unit, controls the cableway.

2. The method according to claim 1, wherein the number of sensors detect a plurality of transverse measurement values, wherein at least two of the plurality of transverse measurement values are detected in different transverse measurement directions.

3. The method according to claim 2, wherein the at least two of the plurality of transverse measurement values is two transverse measurement values.

4. The method according to claim 1, wherein, during operation of the cableway, the number of sensors on the at least one cableway support simultaneously detect the longitudinal measurement value and the transverse measurement value at at least one point in time during passage of one of the cableway vehicles along the cableway support, and
wherein, if the specified condition is met by the ascertained result, the evaluation unit signals a problem in the passage of the one cableway vehicle along the cableway support to the control unit of the cableway for passage monitoring and, depending upon the problem signaled by the evaluation unit, the control unit controls the cableway.

5. The method according to claim 1, wherein the number of sensors in each case detect an acceleration as the longitudinal measurement value and as the transverse measurement value.

6. The method according to claim 1, wherein the number of sensors simultaneously detect the longitudinal measurement value and the transverse measurement value at a plurality of points in time during operation of the cableway.

7. The method according to claim 6, wherein the plurality of points in time during operation of the cableway occur during the passage of one of the cableway vehicles along the cableway support or when the cableway is stationary.

8. The method according to claim 1, wherein an addition, multiplication, or correlation is defined as the mathematical operation.

9. The method according to claim 1, wherein the specified condition comprises an exceedance of a defined maximum value by the ascertained result of the mathematical operation.

10. The method according to claim 9, wherein the defined maximum value depends upon the operation of the cableway.

11. The method according to claim 10, wherein the defined maximum value depends upon a conveying speed of the cableway vehicles on the hoisting cable and/or upon the embodiment of the cableway.

12. The method according to claims 1, wherein the evaluation unit additionally processes the simultaneously detected longitudinal measurement value and transverse measurement value at the at least one point in time, and determines an absolute value of the longitudinal measurement value and an absolute value of the transverse measurement value in order to establish the defined mathematical operation and to ascertain the result from the defined mathematical operation.

13. A cableway comprising:
a number of cableway supports;
a number of cableway vehicles;
a hoisting cable, wherein the cableway vehicles, during operation of the cableway, are movable on the hoisting cable in a conveying direction along the number of cableway supports;
a number of sensors on at least one of the cableway that are configured to detect a movement of the cableway support along the conveying direction as a longitudinal measurement value and to detect at least a movement of the cableway support transverse to the conveying direction as a transverse measurement value,
wherein the number of sensors are further configured to simultaneously detect the longitudinal measurement value and the transverse measurement value at at least one point in time during operation or when the cableway is stationary,
an evaluation unit configured to receive and process the simultaneously detected longitudinal measurement value and transverse measurement value at the at least one point in time from the number of sensors, wherein the evaluation unit is further configured to establish a defined mathematical operation between the simultaneously detected longitudinal measurement value and transverse measurement value at the at least one point in time and to ascertain a result from the defined mathematical operation, and
a control unit,
wherein if a specified condition stored in the evaluation unit is met by the ascertained result, the evaluation unit is configured to signal a problem on the cableway to the control unit for monitoring the cableway, and
wherein, depending upon the problem signaled by the evaluation unit, the control unit is configured to control the cableway.

14. The cableway according to claim 13, wherein the number of sensors comprises one sensor is configured to detect the longitudinal measurement value and the transverse measurement value.

15. The cableway according to claim 14, wherein transverse measurement value includes two transverse measurement values in different transverse measurement directions.

16. The cableway according to claim 13, wherein the number of sensors are provided on more than one of the cableway supports, preferably on each cableway support, of the cableway.

17. The cableway according to claim 16, wherein the number of sensors are provided on each cableway support of the cableway.

18. The cableway according to claim 13, wherein a sensor of the number of sensors is an accelerometer.
